(19) United States
(12) Patent Application Publication
(10) Pub. No.: US 2018/0101384 A1
(43) Pub. Date: Apr. 12, 2018

(54) MORPHED INSTRUCTION ACCORDING TO CONFIGURATION UPDATE

(71) Applicant: Hewlett Packard Enterprise Development LP, Houston, TX (US)

(72) Inventors: Thomas A Keaveny, Auburn, CA (US); Diego Valverde Garro, San Jose (CR)

(21) Appl. No.: 15/565,179

(22) PCT Filed: Apr. 17, 2015
(86) PCT No.: PCT/US15/26412

§ 371 Date: Oct. 9, 2017

(51) Int. Cl. G06F 9/30; G06F 8/41

(52) U.S. Cl. CPC G06F 9/30181; G06F 9/44505; G06F 8/41; G06F 9/30145

(57) ABSTRACT

In some examples, a method includes sending compiled instructions generated from application code to a remote executing unit, the compiled instructions including a particular compiled instruction that maps to a control parameter for the application code. The method may also include receiving a configuration update specifying an updated value for the control parameter, modifying the particular compiled instruction according to the configuration update to obtain a morphed instruction, and sending the morphed instruction to the remote executing unit to replace the particular compiled instruction.

### BACKGROUND

With rapid advances in technology, computing systems are increasingly prevalent in society today. Computing systems execute and support applications that may communicate and process immense amounts of data, many times with performance constraints to meet the increasing demands of users. Increasing the efficiency, speed, and effectiveness of computing systems will further improve user experience.

### BRIEF DESCRIPTION OF THE DRAWINGS

Certain examples are described in the following detailed description and in reference to the drawings.

FIG. 1 shows an example of a system that supports instruction morphing.

FIG. 2 shows an example of control parameter identification and mapping.

FIG. 3 shows an example of a control mapping that maps a control parameter to a particular instruction field of a compiled instruction.

FIG. 4 shows an example of morphed instruction generation according to a configuration update.

FIG. 5 shows an example of a morphed instruction generated using a control mapping.

FIG. 6 shows an example of logic that a control system may implement to support instruction morphing.

FIG. 7 shows an example of a device that supports instruction morphing.

### DETAILED DESCRIPTION

The disclosure below provides systems, devices, circuitry, logic, and methods that support instruction morphing. As described in greater detail below, instruction morphing may include modifying a processor instruction (e.g., a machine instruction) to reflect an update to a control parameter or system setting. Instruction morphing may thus support real-time and on demand adjusting of system configurations, program behavior, control flow, debug hooks, and more, on an instruction-specific level.

In some examples, instruction morphing may be utilized by a control entity managing any number of execution units, e.g., processors or devices. Thus, a network control system may employ instruction morphing to modify individual instructions for execution by network devices (e.g., routers) in a communication system. As another example, a master processor may likewise modify individual instructions for execution by any number of slave processors managed by the master processor. By modifying an instruction itself with an updated control parameter, the control entity may reduce additional latency the executing unit may incur had the updated control parameter been implemented instead through, for example, a memory register access by the execution unit. As the morphed instruction itself includes the updated control parameter, the executing unit may incur reduced or no additional latency to effectuate the updated control parameter. Accordingly, instruction morphing may provide a clean, efficient, and scalable mechanism to propagate configuration changes in a system.

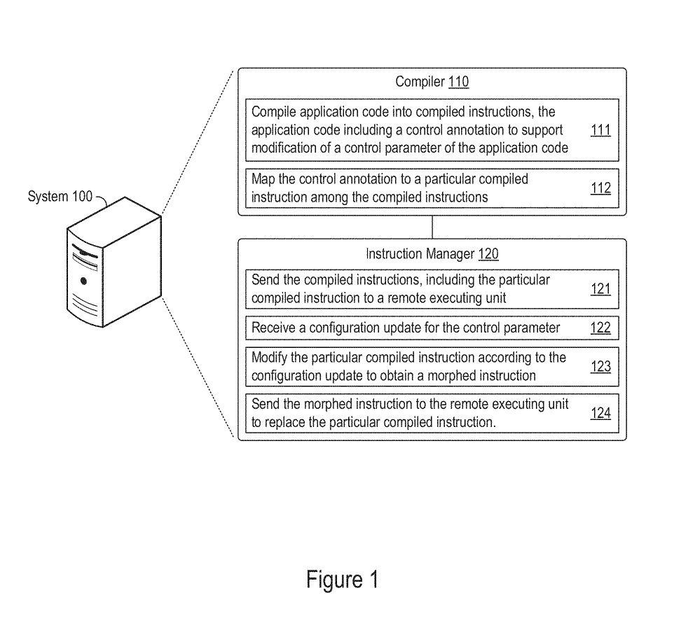

FIG. 1 shows an example of a system 100 that supports instruction morphing. The system 100 may implement a control entity that is communicatively linked to an executing unit, which may be remote or local to the system 100. As examples, the system 100 may implement a network control entity controlling remote routing devices, a master processor controlling a slave processor, a programmable logic controller (PLC) controlling devices in an industrial environment, a production control device managing field level devices in a distributed control system, or any other control entity that provides instructions to a managed executing unit for execution.

The system 100 in FIG. 1 includes a compiler 110 and an instruction manager 120. The compiler 110, instruction manager 120, or both, may be implemented through any combination of hardware, circuitry, executable instructions stored on a machine-readable medium, or various other forms. As described in greater detail below, the compiler 110 and instruction manager 120 may support instruction morphing by linking control parameters annotated in application code to particular compiled instructions generated from the application code that implement the control parameter.

A control parameter may refer to any control point, value, instruction, setting, or other parameter that affects application behavior. As examples, the control parameter may take the form of a quantifiable value used to evaluate a control flow condition in the application code, a selector to determine a particular element among multiple elements, a pointer value, a comparison operator (e.g., less than, greater than, equal to), an instruction operation (e.g., add, subtract, decrement, increment, multiply, and more), loop parameters, an execution criterion or variable for test conditions in a control flow, a target address, label, or code location to branch execution flow to, or any other element that affects the execution of the application code.

For example, in FIG. 1, the compiler 110 includes the modules 111 and 112, through which the compiler 110 may compile the application code into compiled instructions and map the control parameter to a particular compiled instruction among the compiled instructions. The application code may include a control annotation for a control parameter, the control annotation to support modification of the control parameter. In FIG. 1, the instruction manager 120 includes the modules 121, 122, 123, and 124, through which the instruction manager 120 may send the compiled instructions, including the particular compiled instruction, to a remote executing unit; receive a configuration update for the control parameter; modify the particular compiled instruction among the compiled instructions according to the configuration update to obtain a morphed instruction; and send the morphed instruction to the remote executing unit to replace the particular compiled instruction.

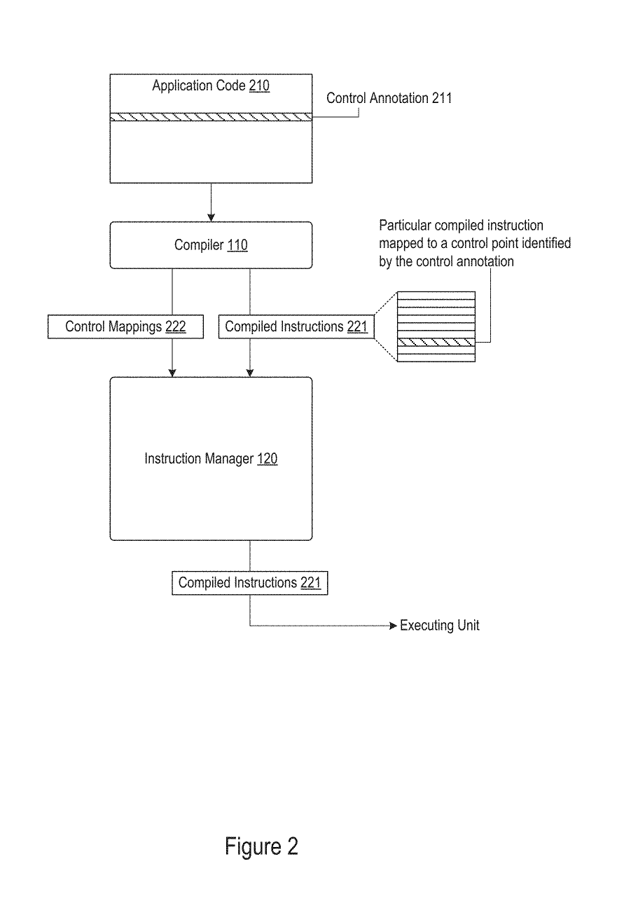

Some instruction morphing examples are present next through FIGS. 2-5. FIG. 2 shows an example of control parameter identification and mapping. In particular, FIG. 2 shows an example of how the compiler 110 and instruction manager 120 may identify a control parameter that can be updated through instruction morphing and map the control parameter to a particular compiled instruction.

The compiler 110 may access application code 210. The application code 210 may include source code for an application or function to be executed by an executing unit. In particular, the application code 210 may include a control annotation 211 through which the compiler 110 may recognize a control point in the application code 210 that is modifiable through instruction morphing. The control annotation 211 may be set at any point in the application code 210, for example by a developer, through any automated control detection methods, or in other ways. The compiler 110 may parse the application code 210 to identify the control annotation 211.

In some examples, the compiler 110 identifies the control annotation 211 for a control parameter according to an annotation syntax. As one example annotation syntax, the compiler 110 may recognize control annotations in the application code 210 according to the following format:
morph_control <name> (DEFAULT)
   In the example annotation syntax above, the “morph_control” string may signal the presence and start of a control annotation in the application code 210. The “name” field may specify a control parameter name that identifies a particular control parameter and the “DEFAULT” field may specify a default value for the control parameter. While example fields and syntax format are provided in the example above, the compiler 110 may be configured to identify a control annotation according to any variety of specific syntax implementations.

To provide a continuing illustration, the application code 210 may include or implement the following code:

#define DEFAULT_MAX_ATTEMPTS 10
while ( counter-- > morph_control FN_max_attempts
(DEFAULT_MAX_ATTEMPTS)) {

result = issue_request (parameters);
if (result.valid) break;

}

In this FN_max_attempts illustration, the compiler 110 may identify a control annotation within a particular portion of the application code 210 above for the control parameter named FN_max_attempts. The compiler 110 may also determine that the control parameter FN_max_attempts has a default value of 10 through the control annotation (e.g., as set through the variable DEFAULT_MAX_ATTEMPTS).

The compiler 110 may identify any number of control annotations in the application code 210. To provide another control annotation example, the control annotation 211 may annotate a control parameter in the form of a comparison operator, for example as the annotation “morph_control FN_comparison (GREATER THAN)”. The compiler 110 may identify the default operator for control parameter FN_comparison as a greater than operation, and later morphing of a compiled instruction could update the FN_comparison control parameter to a less than operation, greater than or equal to operation, or any other operation. Control annotations in the application code 210 may identify control parameters of various other forms as well.

The compiler 110 may compile the application code 210 to generate the compiled instructions 221. As part of or as an addition to compiling the application code 210, the compiler 110 may map a control parameter indicated through a control annotation to a particular compiled instruction. To illustrate with respect to FIG. 2A, the compiler 110 may map the control parameter specified in the control annotation 211 to one or more of the compiled instructions 221 generated from the application code 210, including the particular compiled instruction among the compiled instructions 221 that is shaded in FIG. 2A.

The compiler 110 may determine the particular compiled instruction(s) to map the control parameter according to a location of the control annotation 211 within the application code 210. For instance, the compiler 110 may track which compiled instruction(s) that are generated from compiling the particular portion (e.g., line or instruction) of application code where the control annotation 211 occurs. In the illustration above, the compiler 110 may compile the code portion for the “while” expression, specifically the code for “while (counter→morph_control FN_max_attempts (DEFAULT_MAX_ATTEMPTS)”. The compiled instruction(s) resulting from this portion of the application code 210 may be flagged by the compiler 110 for mapping to the control parameter named FN_max_attempts. In generating the compiled instruction that includes or implements the control parameter, the compiler 110 may set a value for control value as the default value specified in the control annotation 211.

The compiler 110 may map the control parameter indicated by a control annotation to a particular instruction field of a compiled instruction. In that regard, the compiler 110 may map the control parameter to a particular operand or other distinct instruction field of a compiled instruction. As one example, the control parameter FN_max_attempts may be set as a scalar value in an operand field of a branch instruction compiled from the application code 210. The compiler 110 may map the control parameter FN_max_attempts to the particular instruction operand field of the particular branch instruction generated through the compilation process. In other examples, the compiler 110 may map a control parameter to an operation field or address field of a compiled instruction, depending on the particular control parameter being mapped.

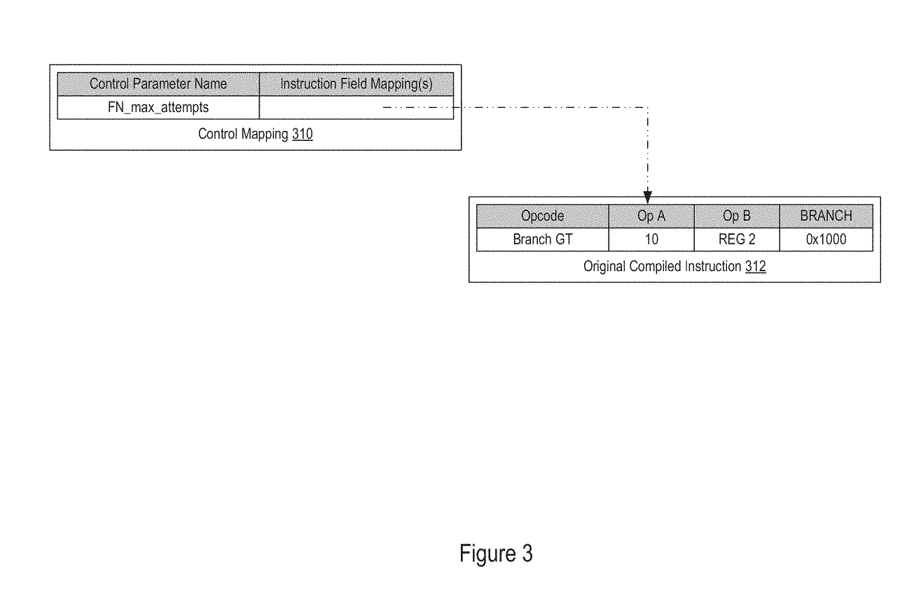

The compiler 110 may track mappings of control parameters to instruction fields of compiled instructions through a control mapping 222. A control mapping 222 may take the form of any data structure that maps a control parameter to a particular compiled instruction or instruction field thereof. The compiler 110 may generate the control mapping 222 as, for example, a table or database, a list of control parameter to instruction field mappings, or in any other data form. In some examples, the control mapping 222 indicates a particular compiled instruction or particular instruction field of the particular compiled instruction as an offset value, e.g., a number of offset bytes from a particular data address or position. An example of a control mapping is also presented in FIG. 3, which is discussed next.

FIG. 3 shows an example of a control mapping 310 that maps a control parameter to a particular instruction field of a compiled instruction. The specific example shown in FIG. 3 continues the example code and control annotation discussed above for the control parameter FN_max_attempts. As seen in FIG. 3, the control mapping 310 includes a control parameter name field to identify the relevant control parameter, which in FIG. 3 is FN_max_attempts.

The control mapping 310 also includes an instruction field mapping field, which may indicate a particular instruction field of compiled instruction that the control parameter maps to. FIG. 3 illustrates conceptually how the control parameter FN_max_attempts maps to the “Op A” field of the original compiled instruction 312, as the control annotation in application code for FN_max_attempts may correspond to the original compiled instruction 312. Continuing the illustration above, the compiler 110 may generate a branch-greater-than machine instruction to compile the “while (counter→morph_control FN_max_attempts (DEFAULT_MAX_ATTEMPTS)” portion of code from the application code. Accordingly, the compiler 110 may populate the control mapping 310 to indicate the mapping of the control parameter FN_max_attempts to the “Op A” field of the original compiled instruction 312. The compiler 110 may specify the instruction field mapping to map to the particular instruction field through, for example, an offset value, a memory address, an instruction and field indicator, or through any other data specifying the compiled instruction and instruction field therein.

The compiler 110 may map a particular control parameter to multiple compiled instructions. Such a scenario may occur when the application code includes multiple control annotations for a particular control parameter. Accordingly, the instruction field mappings field of the control mapping 310 may map the control parameter to the respective instruction field of multiple compiled instructions, such as through multiple offset values. In doing so, the compiler 110 may support morphing of multiple compiled instructions based on the same configuration update.

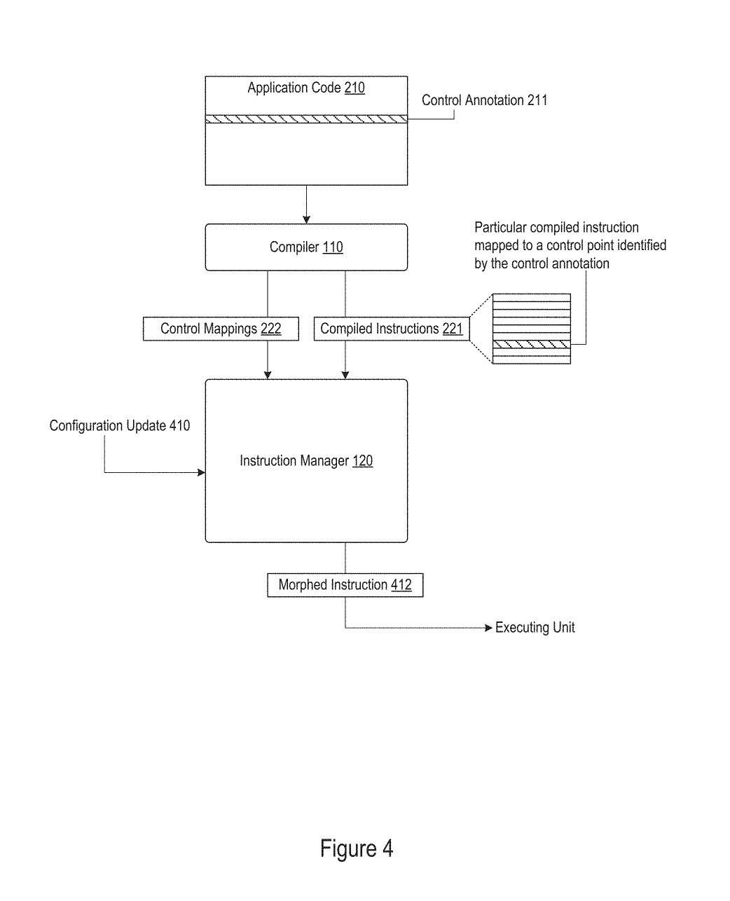

Returning to FIG. 2, the instruction manager 120 may receive the compiled instructions 221 and the control mappings 222 from the compiler 110. The instruction manager 120 may then send the compiled instructions 221 to an executing unit for execution, and the executing unit may include a processor that supports the instruction set architecture of the compiled instructions 221. The compiled instructions 221 may include specific (e.g., default) values for the control parameters as implemented through the compiled instructions 221, which may be subject to later morphing as illustrated through FIG. 4.

Turning to FIG. 4, FIG. 4 shows an example of morphed instruction generation according to a configuration update. In FIG. 4, the instruction manager 120 receives a configuration update 410. The configuration update 410 may be received by the instruction manager 120 after sending the compiled instructions 221 to an executing unit. The configuration update 410 may specify a change to a control parameter for the application code. In the continuing FN_max_attempts illustration, the configuration update 410 may indicate a change to the value of the FN_max_attempts control parameter from 10 to 20, for example.

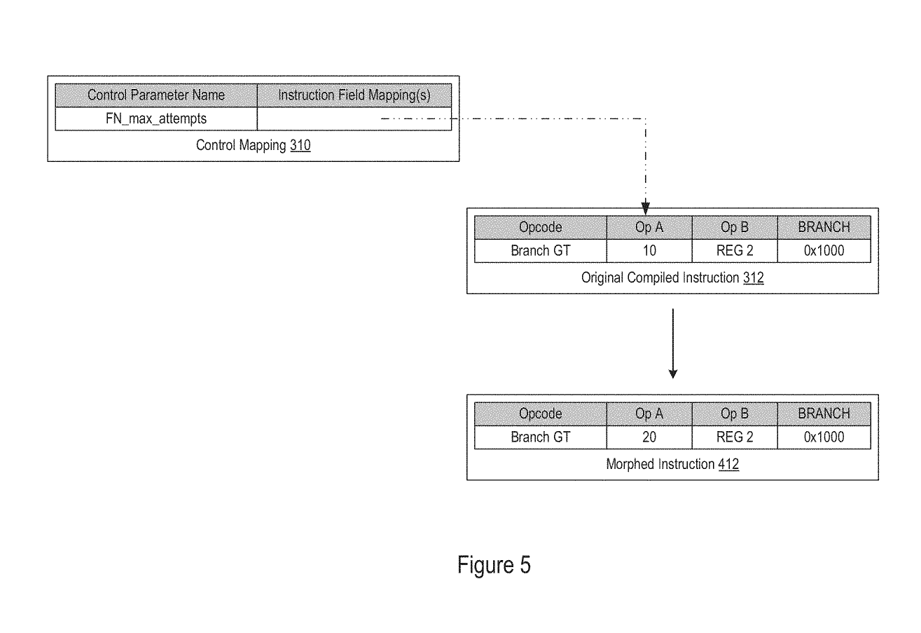

In response to receiving the configuration update 410, the instruction manager 120 may identify a control parameter specified by the configuration update 410 and morph any number of compiled instructions impacted by the configuration update. To do so, the instruction manager 120 may access a control mapping for the control parameter to identify a particular compiled instruction impacted by the configuration update 410, including the particular instruction field that the control parameter maps to. An example of this process is illustrated in FIG. 5, which is discussed next.

FIG. 5 shows an example of a morphed instruction generated using a control mapping. FIG. 5 continues the FN_max_attempts illustration and with reference to the control mapping 310 described in FIG. 3. As seen in FIG. 5 and discussed above, the control mapping 310 maps the control parameter FN_max_attempts to the “Op A” instruction field of the original compiled instruction 312. In response to receiving a configuration update 410 for the FN_max_attempts control parameter, the instruction manager 120 may retrieve the control mapping 310 and identify the original compiled instruction 312 as being affected by the configuration update 410.

The instruction manager 120 may morph (e.g. modify) the original compiled instruction 312 to obtain a morphed instruction 412. As the configuration update 410 may specify an updated value for the control parameter of the application code, the instruction manager 120 may modify the original compiled instruction 312 by updating the mapped instruction field of the particular compiled instruction to the updated value. In the example shown in FIG. 5, the instruction manager 120 modifies the “Op A” instruction field value from 10 (in the original compiled instruction 312) to the updated value of 20 as specified in the configuration update 410. Accordingly, the instruction manager 120 may generate the morphed instruction 412 that includes the updated value of 20 in the “Op A” instruction field, implementing the control parameter change specified by the configuration update 410. For control parameters that map to multiple compiled instructions, the instruction manager 120 may generate multiple morphed instructions by modifying the respective instruction field value of the multiple compiled instructions according to the configuration update 410.

Returning to FIG. 4, the instruction manager 120 may send the morphed instruction 412 to the executing unit to replace a previously sent compiled instruction. As the instruction manager 120 may morph a particular compiled instruction impacted by the configuration update 410 without altering other compiled instructions, the instruction manager 120 may send the morphed instruction 412 to the executing unit without sending the entirety of the compiled instructions 221. That is, the instruction manager 120 may selectively send the morphed instruction 412 without sending others among the compiled instructions 221, e.g., those that remain unchanged by the configuration update 410.

In doing so, the instruction manager 120 may reduce the amount of instructions that the executing unit must reload to effectuate the configuration update 410. Instead of having to reload the entire application code through the compiled instructions 221, the executing unit may instead replace a particular compiled instruction with the morphed instruction 412, while unaffected instructions remain intact and unchanged. Instruction morphing may thus provide a graceful, efficient, and flexible mechanism to update the control parameter on an instruction-level basis.

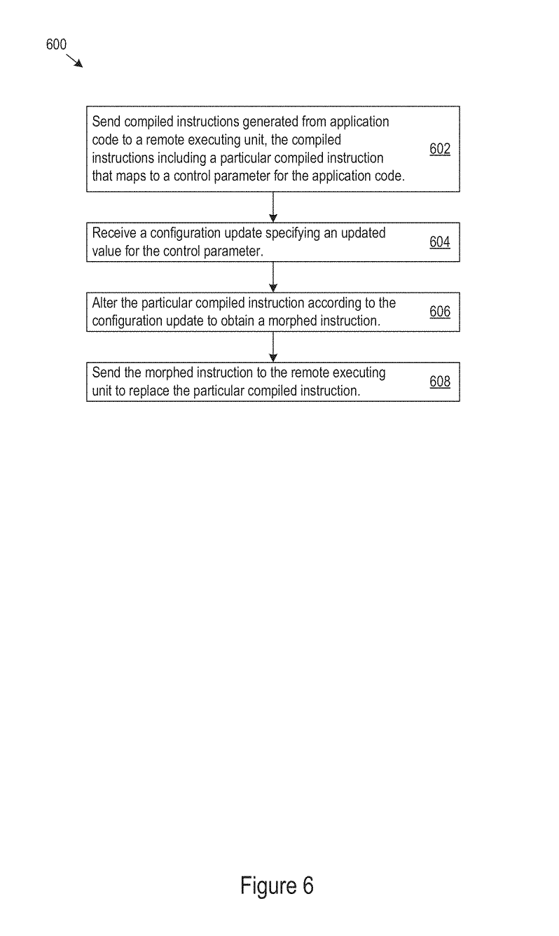

FIG. 6 shows an example of logic 600 that a control system may implement to support instruction morphing. For example, the system 100 may implement the logic 600 as part of the instruction manager 120, the compiler 110, or a combination of both. The control system may implement the logic 600 as hardware, firmware, executable instructions stored on a machine-readable medium, or any combination thereof. The control system may execute the logic 600 as a method or process to support instruction morphing.

By implementing or executing the logic 600, the control system may send compiled instructions generated from application code to a remote executing unit (602). The compiled instructions may include a particular compiled instruction that maps to a control parameter for the application code. The control system may receive a configuration update specifying an updated value for the control parameter for the application code (604). In response to receiving the configuration update, the control system may modify the particular compiled instruction according to the configuration update to obtain a morphed instruction (606). Then, the control system may send the morphed instruction to the remote executing unit to replace the particular compiled instruction (608).

In some examples, the control system may identify a control annotation in the application code for the control parameter. The control annotation may occur at a particular point (e.g., line) in the application code. Thus, the control system may map the control parameter to a particular compiled instruction instructions that correspond to the location of the control annotation. In particular, the control system may and map the control parameter to a particular instruction field that implements the control parameter, such as a particular instruction operand storing the value of the control parameter. Thus, the control system may modify the particular compiled instruction according to the configuration update by setting the particular instruction field of the particular compiled instruction to the updated value specified by the configuration update.

The configuration update may be set in various ways. In some examples, the control system receives the configuration update as a user-specified change to the control parameter, e.g., through a user interface or user dashboard. In other examples, the configuration updates may be automated according to any number of update criteria, examples of which include time of day, resource bandwidth, consumption, or availability thresholds, environmental triggers, and more.

The control system may send the morphed instruction to an executing unit logically or physically remote to the control system. The control system may manage multiple executing units, and thus the control system may send the morphed instruction to multiple remote executing units. In some examples, the control system sends the morphed instruction during an initialization state of the remote executing unit, e.g., when a remote device receiving instructions from the control system starts a boot sequence or initially powers up. In some examples, the control system sends the morphed instruction during a run-time state of the executing unit. As such, the control system may utilize instruction morphing to implement real-time configuration changes to the remote executing unit without disrupting real-time processing by the executing unit. For example, in a communication network scenario, a network control device may utilize instruction morphing to propagate updated routing parameters to managed network devices to meet in-line processing requirements of the managed network devices.

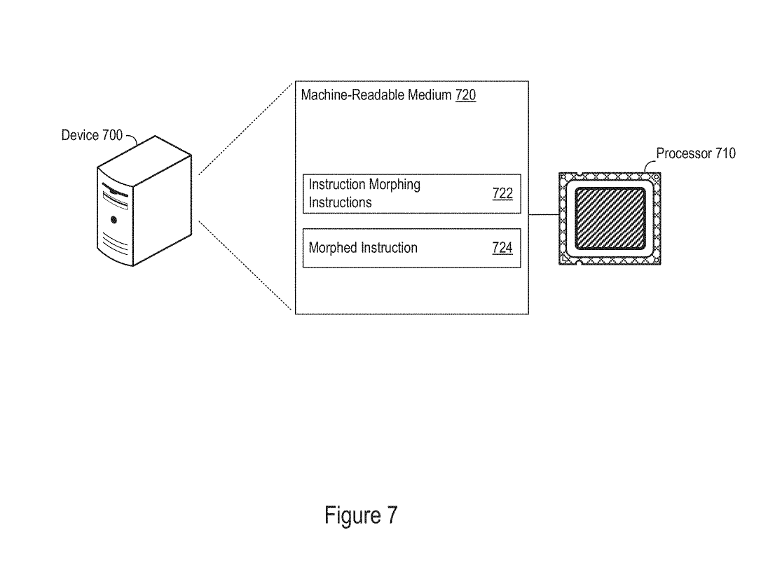

FIG. 7 shows an example of a device 700 that supports instruction morphing. The device 700 may include a processor 710. The processor 710 may include a central processing unit (CPU), microprocessor, and/or any hardware device suitable for executing instructions stored on a machine-readable medium.

The device 700 may include a machine-readable medium 720. The machine-readable medium 720 may be any electronic, magnetic, optical, or other physical storage device that stores executable instructions, such as the instruction morphing instructions 722 shown in FIG. 7. Thus, the machine-readable medium 720 may be, for example, Random Access Memory (RAM), an Electrically-Erasable Programmable Read-Only Memory (EEPROM), a storage drive, an optical disk, and the like.

The device 700 may execute instructions stored on the machine-readable medium 720 through the processor 710. Executing the instructions may cause the device 700 to perform any combination of the features described herein, including features with respect to the compiler 110 and the instruction manager 120. To illustrate, executing the instruction morphing instructions 722 may cause the device 700 to map a control annotation in application code to a particular compiled instruction among compiled instructions generated from the application code, the control annotation identifying a control parameter for the application code; send the compiled instructions generated from the application code, including the particular compiled instruction, to a remote executing unit; receive a configuration update specifying a change to the control parameter; modify the particular compiled instruction according to the configuration update to obtain a morphed instruction 724, the morphed instruction 724 implementing the change to the control parameter; and send the morphed instruction 724 to the remote executing unit to replace the particular compiled instruction.

In some examples, executing the instruction morphing instructions 722 may further cause the device 700 to map the control parameter to a particular instruction field of the particular compiled instruction. As another example, executing the instruction morphing instructions 722 may further cause the device 700 to identify the control parameter in the application code by identifying a control annotation for the control parameter in the application code. As yet another example, executing the instruction morphing instructions 722 may further cause the device 700 to send the morphed instruction to multiple remote executing units.

The methods, devices, systems, and logic described above, including the compiler 110, the instruction manager 120, or both, may be implemented in many different ways in many different combinations of hardware, executable instructions stored on a machine-readable medium, or both. For example, the compiler 110, the instruction manager 120, or both, may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. A product, such as a computer program product, may include a storage medium and machine readable instructions stored on the medium, which when executed in an endpoint, computer system, or other device, cause the device to perform operations according to any of the description above.

The processing capability of the systems, devices, and circuitry described herein, including the compiler 110 and the instruction manager 120, may be distributed among multiple system components, such as among multiple processors and memories, optionally including multiple distributed processing systems. Parameters, databases, and other data structures may be separately stored and managed, may be incorporated into a single memory or database, may be logically and physically organized in many different ways, and may implemented in many ways, including data structures such as linked lists, hash tables, or implicit storage mechanisms. Programs may be parts (e.g., subroutines) of a single program, separate programs, distributed across several memories and processors, or implemented in many different ways, such as in a library, such as a shared library (e.g., a dynamic link library (DLL)). The DLL, for example, may store code that performs any of the system processing described above.

While various examples have been described above, many more implementations are possible.

1. A system comprising:
a compiler to:
compile application code into compiled instructions, the application code including a control annotation for a control parameter, the control annotation to support modification of the control parameter; and
map the control parameter to a particular compiled instruction among the compiled instructions; and
an instruction manager to:
send the compiled instructions, including the particular compiled instruction, to a remote executing unit:
receive a configuration update for the control parameter;
modify the particular compiled instruction among the compiled instructions according to the configuration update to obtain a morphed instruction; and
send the morphed instruction to the remote executing unit to replace the particular compiled instruction.

2. The system of claim 1, wherein the compiler is to map the control annotation to a particular compiled instruction field of the particular compiled instruction.

3. The system of claim 2, wherein the configuration update specifies an updated value for the control parameter of the application code; and
wherein the instruction manager is to modify the particular compiled instruction by updating the particular field of the particular compiled instruction to the updated value.

4. The system of claim 1, wherein the compiler is further to map the control parameter to multiple compiled instructions; and
wherein instruction manager is further to:
determine that the configuration update for the control parameter affects multiple compiled instructions, including the particular compiled instruction; and
modify the multiple compiled instructions according to the configuration update to obtain multiple morphed instructions.

5. The system of claim 1, wherein the instruction manager is to send the morphed instruction to the remote executing unit to replace the particular compiled instruction without sending other compiled instructions among the compiled instructions.

6. A method comprising:
sending compiled instructions generated from application code to a remote executing unit, the compiled instructions including a particular compiled instruction that maps to a control parameter for the application code;
receiving a configuration update specifying an updated value for the control parameter;
modifying the particular compiled instruction according to the configuration update to obtain a morphed instruction; and
sending the morphed instruction to the remote executing unit to replace the particular compiled instruction.

7. The method of claim 6, further comprising:
identifying a control annotation in the application code for the control parameter; and
mapping the control parameter to a particular instruction field of the particular compiled instruction.

8. The method of claim 7, wherein modifying the particular compiled instruction comprises setting the particular instruction field of the particular compiled instruction to the updated value specified by the configuration update.

9. The method of claim 6, wherein receiving the configuration update comprises receiving a user-specified change to the control parameter.

10. The method of claim 6, wherein sending the morphed instruction comprises sending the morphed instruction during a run-time state of the executing unit.

11. The method of claim 6, comprising sending the morphed instruction to multiple executing units.

12. A non-transitory machine-readable medium storing executable instructions to:
map a control parameter in application code to a particular compiled instruction among compiled instructions generated from the application code;
send the compiled instructions generated from the application code, including the particular compiled instruction, to a remote executing unit;
receive a configuration update specifying a change to the control parameter;
modify the particular compiled instruction according to the configuration update to obtain a morphed instruction, the morphed instruction implementing the change to the control parameter; and
send the morphed instruction to the remote executing unit to replace the particular compiled instruction.

13. The non-transitory machine-readable medium of claim 12, wherein the executable instructions are further to map the control parameter to a particular instruction field of the particular compiled instruction.

14. The non-transitory machine-readable medium of claim 12, wherein the executable instructions are further to identify the control parameter in the application code by identifying a control annotation for the control parameter in the application code.

15. The non-transitory machine-readable medium of claim 12, wherein the executable instructions are to send the morphed instruction to multiple remote executing units.
